(19) United States
(12) Patent Application Publication
(10) Pub. No.: US 2022/0184859 A1
(43) Pub. Date: Jun. 16, 2022

(54) METHOD AND OBJECTS FORMED FROM POLYUREA POLYMERS

(71) Applicant: San Juan Patents, Inc., Lakeland, FL (US)

(72) Inventor: Kirk Sullivan, Lakeland, FL (US)

(21) Appl. No.: 17/122,514

(22) Filed: Dec. 15, 2020

(51) Int. Cl. B29C 41/08; B29C 41/22; E04H 4/00

(52) U.S. Cl. CPC B29C 41/08; B29K 2063/00; E04H 4/0037; B29C 41/22

(57) ABSTRACT

Methods for forming large molded objects from polyurea coatings that are exceptionally durable, rigid and strong enough to remain intact under all conditions involving structural integrity, even without structural reinforcements. Such methods comprise providing a mold or substrate surface onto which the molded object will be formed. A first gelcoat layer is formed upon the mold, upon which is formed a second epoxy/polyurea coating, followed by a third polyurea coating mixed with chopped fiberglass, and a final fourth epoxy/polyurea coating. The combined coatings are allowed to cure and then removed from the mold. Such methods are exceptionally effective in the manufacture of pools and spas.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention is directed to methods for the rapid manufacture of molded objects from polyurea-based coatings, and in particular, large-scale molded products such as swimming pools and spas that are exceptionally durable and structurally robust.

Processes for forming molded objects are well-known in the art. While there are numerous techniques for forming molded objects, such as blow molding, compression molding, extrusion molding, and injection molding, the present invention focuses on manufacturing processes that involve shaping a liquid or malleable raw material by using a fixed, pre-formed surface or substrate, known as a mold. Generally, such processes comprise applying a liquid or molten material within or about a mold or substrate and thereafter allowed to cool or cure into a hardened structure, after which the structure is removed from the mold/substrate upon which the structure was formed.

Among the types of applications that deploy such molding processes are the manufacture of objects formed from fiberglass, and in particular, large-scale objects such as fiberglass swimming pools and spas. Typical fabrication methods for such products will involve forming multiple layers of coatings or materials in a sequential manner over a mold that ultimately form a finished swimming pool/spa that is released from the mold and ready for installation. Because of the need to manufacture an exceptionally durable product that can withstand years, if not decades of use outdoors with potentially wide-ranging changes in temperature, moisture, UV exposure and expanding/contracting soil, all while holding a large quantity of water, manufacturing fiberglass pools of high quality requires meticulous construction methods and the use of large quantities of materials.

In this regard, for the typical manufacture of a fiberglass pool, a manufacturer will initially spray a gelcoat about the mold having the desired shape of the pool to be made. Thereafter, a coating of chopped fiberglass mixed with vinyl ester resin in applied to impart structural rigidity and durability to the pool, followed by the integration of reinforcing structures and materials such as fiberglass blankets and the like, especially to areas requiring enhanced support or strength. At least one and often time more than one further layer of polyester resin is applied over the previously formed layers such that ultimately a rigid, multi-layer structure is formed about the mold and allowed to cure. From that point, the finished pool can be released from the mold and further processed to remove excess fiberglass, inspect for quality, plus other finishing steps.

While such manufacturing processes have proven to result in exceptionally well-built and durable fiberglass-based structures, numerous drawbacks exist with such processes. First, the multi-layer construction process is both time and labor intensive, and further requires a multi-stage application process. Indeed, large quantities of fiberglass and resin must be used in the manufacture of every pool and spa and applied with sufficient thickness to meet demanding product specifications. Care must likewise be taken to ensure supplemental reinforcing materials and support structures are adequately integrated within the pool to prevent possible product failure, such as cracking in the pool once installed. Typical fiberglass molding manufacturing process also can take several days to produce a single pool. Indeed, the curing step alone averages at least one day.

Accordingly, there is a substantial need in the art for an improved molding process that can be utilized to form molded structures that are exceptionally durable and structurally robust that are greatly simplified than current molding processes, especially fiberglass molding practices. There is likewise a need for such methods that are significantly faster, use less materials and can typically dispense with the need for further reinforcing/support structures as must usually be integrated into large-scale items molded from fiberglass, and in particular fiberglass swimming pools and spas. There is yet a further need in the art for such methods that can be deployed using conventional molds, spraying and coating techniques known in the art and thus do not require retooling or other large capital costs to use.

### BRIEF SUMMARY

The present invention specifically addresses and alleviates the above-identified deficiencies in the art. Specifically, the present invention is directed to methods for the rapid manufacture of molded objects from polyurea-based coatings that are exceptionally durable and do not need any kind of reinforcing materials, such as framing or bracing structures, to maintain their shape and function. The methods of the present invention and objects formed thereby are exceptionally well-suited for the manufacture of large-scale molded objects, and in particular swimming pools and spas where the finished pool/spa product possesses exceptional strength to withstand long-term, in-ground installation in virtually every type of climate.

According to a preferred embodiment, the methods initially involve the step of providing a convention mold or substrate surface having a pre-defined exterior shape that will serve to receive the coatings applied thereto that, when cured, will define the shape of the molded object as per conventional molding processes. To that end, the molds may take any of a variety of forms known in the art, including fiberglass molds having a tooling-gel exterior surface covered with a standard wax mold release agent.

A first polyurea gelcoat coating is then sprayed upon the mold surface via conventional spraying techniques and equipment known in the art. The first polyurea composition will preferably comprise of a polyaspartic coating that is evenly applied about the mold to a thickness ranging from 20-25 mils. Among the types of polyurea coating exceptionally well-suited for such applications is GelFlex two component polyaspartic coating manufactured by VersaFlex, Inc. of Kansas City, Kans. Advantageously, the coating need only set for 45 seconds to a minute and thus allows for rapid manufacturing. The coating can also be pigmented as desired for a given application.

Within three hours or less after application of the first coating, a second polyurea coating is applied over the first coating. Such polyurea coating will preferably comprise a novolac epoxy/polyurea hybrid coating formulated to be surface tolerant and hydrophobic in order to provide waterproofing properties and adhesion. An exemplary coating includes AquataFlex® 506 produced by Raven Lining Systems of Kansas City, Kans., in conjunction with VersaFlex, Inc. Such coating may be applied per conventional spraying techniques and equipment and will preferably be applied to a thickness ranging from 60 to 80 mils.

Due to its rapid set time, immediately following application of the second coating a third coating is applied thereover. Such coating will comprise a performance modified, reinforcing polyurea spray coating/lining material, an exemplary coating being VersaFlex Inc.'s AroStruct brand of structural, two-component performance modified polyurea spray coating/lining material. Such material is designed specifically for industrial applications and is exceptional for applications that receive constant or intermittent attack from contained materials, subsurface hydrostatic pressure, corrosive substances and abrasive action. Such material is further advantageously rigid and strong enough to remain intact under all conditions involving structural integrity, even without reinforcements.

To provide greater material strength in the finished, molded product, chopped fiberglass will be added to the third coating as it is being applied. In such applications, it is contemplated that such chopped fiberglass will be added in an amount ranging from approximately 40% to 60% by weight relative the third polyurea coating and mixed to have a uniform consistency while being applied. To that end, the third coating will be applied via conventional spraying techniques and equipment as utilized in fiberglass molding applications and will preferably be applied via multiple spraying passes such that a uniform layer from 250 to 300 mils is ultimately formed over the second coating.

Following application of the third coating, a fourth and final coating is applied thereover. The fourth coating will preferably be the same as the second novolac epoxy/polyurea hybrid coating and applied via the same conventional manner and to the same thickness range of 60 to 80 mils.

Following the application of the fourth coating, the mixture of coatings is then allowed to cure for approximately one hour, after which the four coatings will have bonded to one another to form the finished molded structure. Per convention molding processes, the molded structure may be removed from the mold and utilized as desired. Advantageously, when the processes of the present invention are utilized to manufacture spas, swimming pools and the like, the molded structure is immediately ready for shipping and installation. Not only is the molded spa/pool ready for installation into the ground and receive water, the combination of polyurea materials are capable of withstanding long term forces and conditions, such as expansive and contracting soil, greatly varying weather conditions and resistance to UV radiation to a degree believed to be at least equal to pools and spas manufactured from fiberglass. Moreover, the pools and spas as formed by the methods of the present invention are dramatically faster to manufacture and multiple pools can be made in a single day, as opposed to a multi-day manufacturing process required for fiberglass pool and spa production.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic block diagram for performing a method for the rapid manufacture of molded objects from polyurea-based coatings according to a preferred embodiment of the present invention;

FIG. 2 is a perspective view of a first polyurea coating being sprayed upon a mold by an individual;

FIG. 3 is a perspective view of a second polyurea coating being sprayed upon the first coating as shown in FIG. 2;

FIG. 4 is a perspective view of a third polyurea coating being sprayed upon the second coating as shown in FIG. 3;

FIG. 5 is a perspective view of a fourth polyurea coating being sprayed upon the third coating as shown in FIG. 4;

FIG. 6 is an exploded view of the combined solidified coatings applied as shown in FIGS. 2-4 shown being removed from the mold; and

FIG. 7 is a perspective view of a spa as formed by the multiple coatings and removed from the mold in FIG. 5.

### DETAILED DESCRIPTION

The detailed description set forth below in connection with the appended drawings is intended as a description of the presently preferred embodiment of the invention, and is not intended to represent the only form in which the present invention may be constructed or utilized. The description sets forth the functions and the sequence of steps for developing and operating the invention in connection with the illustrated embodiment. It is to be understood, however, that the same or equivalent functions and sequences may be accomplished by different embodiments that are also intended to be encompassed within the spirit and scope of the invention.

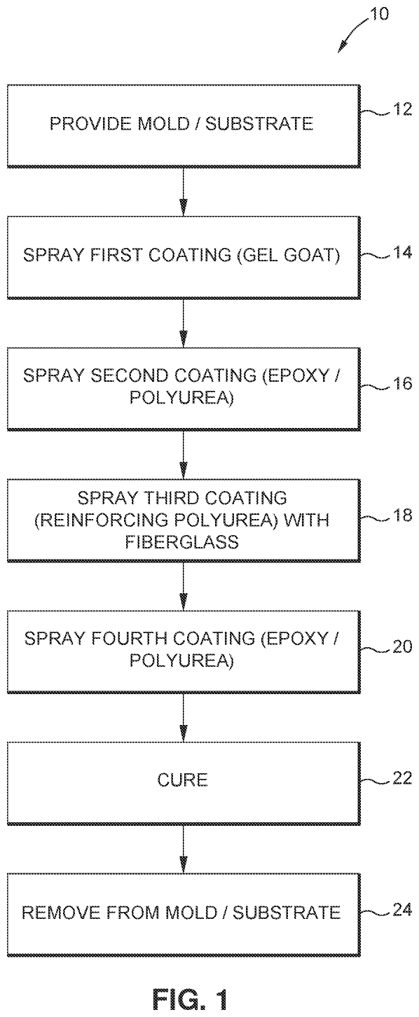

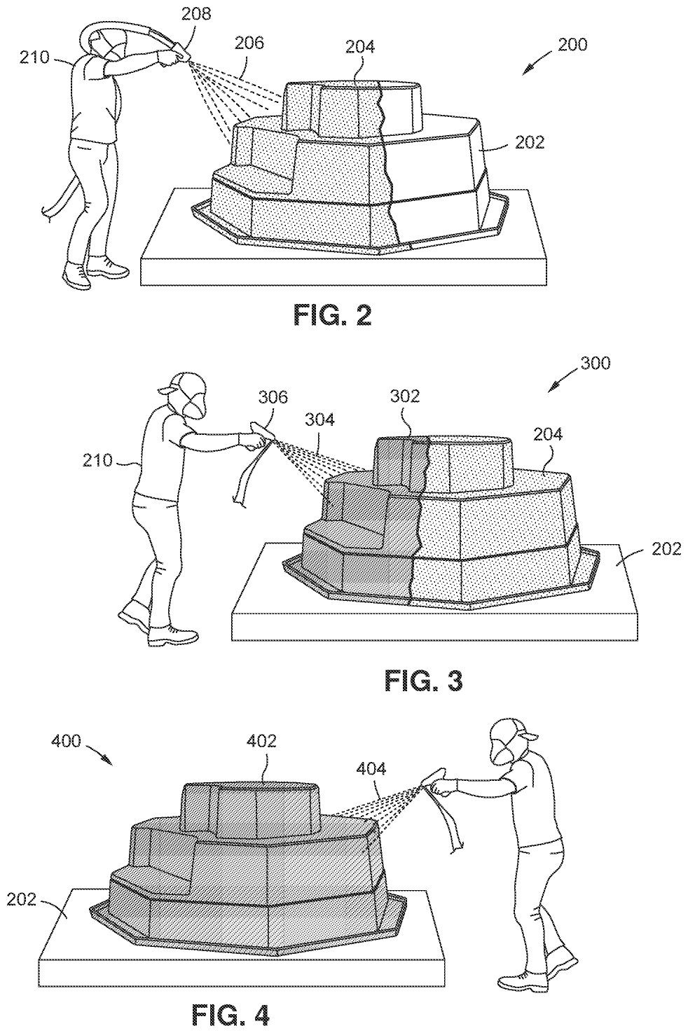

Referring now to the drawings, and initially to FIG. 1, there is shown a schematic diagram for sequentially preforming a method 10 for the rapid manufacture of molded objects from polyurea-based coatings according to a preferred embodiment of the present invention. Such method 10 involves forming the molded object via four sequentially applied coatings of polymers, discussed more fully below, upon a mold or substrate per conventional molding processes. To that end, the method contemplates a mold or substrate will be provided in initial step 12 that will serve as the basis for forming the molded structure. Such mold or substrate may take any of a variety of forms known in the art that are operative to define an exterior shape that will serve to receive the coatings applied thereto that, when cured, will define the shape of the molded object. Exemplary of such molds include fiberglass molds having a tooling-gel exterior surface covered with a standard wax mold release agent as are utilized in the production of fiberglass pools and spas, such as spa mold 202 as shown in FIGS. 2-6.

To such mold provided for in step 12, there is applied via step 14 a first coating that will preferably serve as a gelcoat. The first polyurea coating will preferably comprise a polyaspartic polyurea coating that may take the form of a two-component polyurea elastomer spray. Among the types of polyurea coating exceptionally well-suit for such applications is GelFlex polyaspartic coating manufactured by VersaFlex Inc. of Kansas City, Kans. that provides for a first component or A Side with the following formulation:

| | | Weight |
|---|---|---|
| | CAS | Concentration |
| Chemical Name | number | % |
| Hexamethylene Diisocyanate | 28182-81-2 | 90-100% |
| Homopolymer | | |

The second component or B Side with the following formulation:

| | | Weight |
|---|---|---|
| | CAS | Concentration |
| Chemical Name | number | % |
| Aspartic Acid Ester 1 | 68253-59-6 | 40-50% |
| Cycloaliphatic Amine | | 20-30% |
| Titanium Dioxide | 13463-67-7 | 0-20% |
| Amine-based Polyol | | 5-10% |
| Trade Secret | | 5-10% |
| Fumaric Acid Diester | 623-91-6 | 1-5% |
| Adhesion Promoter | | 0.1-1% |
| Amorphous Hydrophobic Fumed Silica | 67762-90-7 | 0-0.1% |

Per the manufacturer's instructions, Sides A and B are mixed in a 1:1 ratio by volume with Side B being pre-mixed. The polyurea coating can also be pigmented as desired for a given application, such as to give a pool/spa a desired color.

Such first coating is applied in step 14 via spraying technique 200 as illustrated in FIG. 2. Preferably the polymer coating 204 is evenly applied about the mold to a thickness ranging from 20 to 25 mils. To that end, it is contemplated that coating 204 can be applied to the mold 202 via conventional spraying 206 using conventional spraying equipment 208 as applied by an individual 210 making passes about the mold 202 to ensure even application. Advantageously, due to the chemical properties of the first gelcoat, the coating 204 need only set for 45 seconds to a minute and thus allows for rapid manufacturing.

Within three hours or less after application of the first coating 204, a second polyurea coating 302 is applied over the first coating 204 per step 16 in FIG. 1 and shown as 300 in FIG. 3. Such coating 302 will preferably comprise a novolac epoxy/polyurea hybrid coating formulated to impart increased stiffness and provide an additional waterproof barrier. An exemplary coating material includes AquataFlex® 506 produced by Raven Lining Systems of Kansas City, Kans., in conjunction with VersaFlex, Inc. Such coating is surface tolerant and is hydrophobic to provide excellent waterproofing properties and adhesion. Like the first gelcoat coating, the second coating will comprise a two-part spray. The first component or A Side includes the following formulation:

| | | Weight |
|---|---|---|
| | CAS | Concentration |
| Chemical Name | number | % |
| Polyurethane Prepolymer | | 30-60% |
| Diphenylmethane Diisocyanate (MDI) | 26447-40-5 | 10-30% |
| Mixed Isomers | | |
| 4,4′-Diphenylmethane Diisocyanate (MDI) | 101-68-8 | 10-30% |

The second component or B Side includes the following formulation:

| | | Weight |
|---|---|---|
| | CAS | Concentration |
| Chemical Name | number | % |
| Diethyltoluenediamine | 68479-98-1 | 5-10% |
| Trade Secret | | 1-5% |
| Titanium Dioxide | 13463-67-7 | 0-5% |
| Polyether Polyol | 25791-96-2 | 1-5% |
| Cashew, nutshell liquid | 8007-24-7 | 1-5% |
| Trade Secret | | 1-2% |
| Carbon Black | 1333-86-4 | 0-1% |

Per the manufacturer's instructions, Sides A and B are mixed in a 1:1 ratio by volume with Side B being pre-mixed. Sides A and B are likewise preferably warmed to a minimum of 70° F. prior to processing. Such coating may be applied via conventional spraying techniques 304 utilizing conventional spraying equipment 306 known in the art and will be applied to a thickness ranging from approximately 60 to 80 mils. Advantageously, the second coating 302, due to its formulation, sets very rapidly and once applied to the correct thickness range can immediately accommodate the application of the third coating at step 18 of FIG. 1.

Step 18, also shown as application 400 of a third reinforcing coating 402 in FIG. 4, preferably comprises spraying a performance modified, reinforcing polyurea coating/lining material formulated for industrial applications that receive constant or intermittent attack from contained materials, subsurface hydrostatic pressure, corrosive substances and abrasive action. Among the types of such suitable polyurea reinforcing coating materials 402 well suited for practicing the present invention include commercially available 100% solids, semi-structural, two-component performance modified polyurea spray coating/lining. An exemplary reinforcing polyurea coating as applied in step 18 includes VersaFlex Inc.'s AroStruct brand of structural polyurea spray coating/lining material. Per the other aforementioned coatings, the AroStruct coating is a two-component formulation wherein the first component or Side A comprises:

| | | Weight |
|---|---|---|
| | CAS | Concentration |
| Chemical Name | number | % |
| Polymeric Diphenylmethane Diisocyanate | 9016-87-9 | 50-60% |
| (pMDI) | | |
| 4,4′-Diphenylmethane Diisocyanate | 101-68-8 | 30-40% |
| (MDI) | | |
| Isocyanic acid, polymethylenepoly- | 58228-05-0 | 1-5% |
| phenylene ester, polymer with | | |
| methyloxirane polymer with oxirane | | |
| ether with 1,2,3-propanetriol (3:1) | | |
| Oxirane, methyl-, polymer with oxirane, | 112898-48-3 | 1-5% |
| ether with 1,2,3-propanetriol (3:1), | | |
| polymer with 1,1′- | | |
| methylenebis[isocyanatobenzene] | | |
| 2,4′-Diphenylmethane Diisocyanate | 5873-54-1 | 1-5% |
| (MDI) | | |

The second or Side B component of the preferred AroStruct coating is formulated as follows:

| | | Weight |
|---|---|---|
| | CAS | Concentration |
| Chemical Name | number | % |
| Trade Secret | | 30-40% |
| Amine-based Polyol | | 20-30% |
| Polyoxyalkyleneamine | 9046-10-0 | 20-30% |
| Glycerine, propoxylated aminated | 64852-22-8 | 5-10% |
| Diethyltoluenediamine | 68479-98-1 | 5-10% |
| Titanium Dioxide | 13463-67-7 | 0-5% |
| Trimethylolpropane | 77-99-6 | 1-5% |
| Polyether Polyol | 25791-96-2 | 0-5% |
| Carbon Black | 1333-86-4 | 0-1% |

Per the manufacturer's instructions, Sides A and B are mixed in a 1:1 ratio by volume with Side B being pre-mixed. Sides A and B are likewise preferably warmed to a minimum of 70° F. prior to processing.

To provide greater strength and structural reinforcement to the finished molded product, chopped fiberglass will be added to and mixed with the third coating so that the coating will be applied as a uniform mixture of polyurea coating and fiberglass over the second coating 302. Ideally, the chopped fiberglass will be added in an amount ranging from 40% to 60% by weight of the coating material.

As shown in FIG. 4, the application 400 of the third coating 402 can be applied via conventional spraying techniques 404 by the individual 210, including those techniques well-know for spraying fiberglass/polymer mixtures, and will preferably be applied via multiple spraying passes such that a uniform layer from 250 to 300 mils is ultimately formed over the second coating 302.

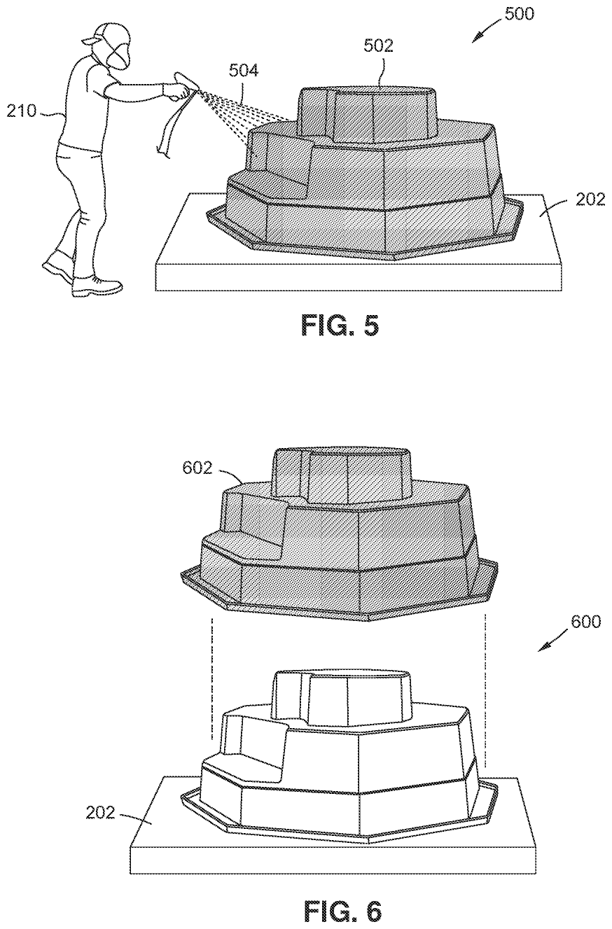

Once the third coating 402 is applied, a final fourth coating is then formed over thereover in step 20 of FIG. 1 and shown as application 500 in FIG. 5. The fourth coating 502 will preferably comprise the same novolac epoxy/polyurea hybrid coating utilized in step 16 and applied in the same manner and thickness of 60 to 80 mils.

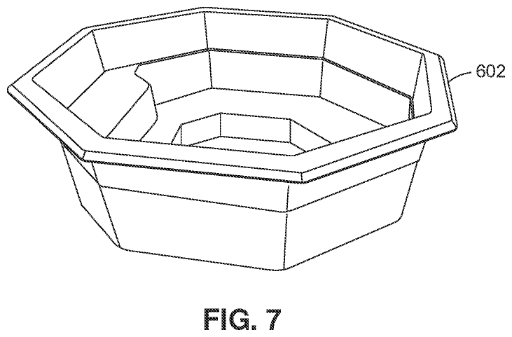

Following the application of the fourth or final coating 20 that is ultimately applied per FIG. 1, the mixture of coatings is then allowed to cure per step 22 of FIG. 1 upon the mold 202 or substrate for approximately one hour, after which the coatings 204, 302, 402, 502 will have cooperated to form the finished molded structure, illustrated as 602 in FIGS. 6 and 7. Per convention molding processes, the molded structure 602 may be removed from the mold per step 24 of FIG. 1, and further illustrated as separation 600 from the mold 202 as shown in FIG. 6, per conventional molding techniques. The molded structure 602 formed from the cured layers of polyurea can then be processed via conventional finishing techniques and inspected for quality to make the finished product shown in FIG. 7 and thereafter utilized as desired.

Advantageously, molded objects formed by the methods of the present invention can be rapidly produced and can further be made on a large-scale basis without the need to utilize reinforcing or other support structures, although such structures can be incorporated if desired and/or to impart greater structural strength. Moreover, the processes of the present invention when utilized to manufacture spas, swimming pools and the like, dramatically expedite manufacturing and multiple pools can be made in a single day, as opposed to a multi-day manufacturing process required for fiberglass pool and spa production. Along those lines, such molded pools and spas, once formed, are ready for shipping and installation as per conventional fiberglass pools and spas. Not only are such molded spas/pools ready for installation into the ground and receive water, the combination of polyurea materials, like fiberglass spas/pools, are capable of withstanding expansive and contracting soil, varying weather conditions and resistance to UV radiation to a degree and for a longevity believed to be at least equal to pools and spas manufactured from fiberglass.

The above description is given by way of example, and not limitation. Given the above disclosure, one skilled in the art could devise variations that are within the scope and spirit of the invention disclosed herein, including various ways of applying multiple layers of polyurea coatings upon a mold or substrate to produce a molded object as contemplated herein, which need not be limited in any way to swimming pools, spas and the like. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method for the manufacture of a molded object comprising the steps:
a) providing a mold defining an outer surface upon which said molded object will be formed;
b) spraying a polyaspartic coating upon said outer surface of said mold provided in step a) such that a first coating is formed;
c) spraying an epoxy/polyurea coating over said first coating formed in step b) such that a second coating is formed;
d) spraying a mixture of a reinforcing polyurea polymer with chopped fiberglass upon said second coating formed in step c) such that a third coating is formed;
e) spraying an epoxy/polyurea over said third coating formed in step d) such that a fourth coating is formed;
f) allowing said coating in step e) to cure such that said first, second, third and fourth coatings cooperate to form said molded object upon said mold; and
g) removing said molded object formed in step f) from said mold.

2. The method of claim 1 wherein in step b), said coating is formed to have a thickness ranging from 20 to 25 mils.

3. The method of claim 1 wherein in step d), said coating is formed to have a thickness of ranging from 250 to 300 mils.

4. The method of claim 1 wherein in steps c) and e), said coatings is formed to have a thickness ranging from 60 to 80 mils.

5. The method of claim 1 wherein a cure time ranging from 45 seconds to 3 hours is allowed to lapse from when step b) is performed to when step c) is performed.

6. The method of claim 1 wherein said molded object comprises a swimming pool.

7. The method of claim 1 wherein said molded object comprises a spa.

8. The method of claim 1 wherein in step d) said chopped fiberglass is added in an amount ranging from 40% to 60% by weight of said performance modified polyurea.

9. The method of claim 13 wherein said chopped fiberglass is added in an amount of approximately 20% by weight of said reinforcing polyurea polymer.

10. The pool produced by the method of claim 6.

11. The spa produced by the method of claim 7.
